(19) United States
(12) Patent Application Publication
(10) Pub. No.: US 2025/0183939 A1
(43) Pub. Date: Jun. 5, 2025

(54) COMMUNICATION SYSTEM AND COMMUNICATION DEVICE

(71) Applicant: CANON KABUSHIKI KAISHA, Tokyo (JP)

(72) Inventors: MASARU TOMABECHI, Kanagawa (JP); RYOTA YAMADA, Chiba (JP)

(21) Appl. No.: 18/930,888

(22) Filed: Oct. 29, 2024

(30) Foreign Application Priority Data
Nov. 30, 2023 (JP) 2023-203012

(51) Int. Cl. H04B 5/72; H01Q 3/02; H04B 5/40

(52) U.S. Cl. CPC H04B 5/72; H01Q 3/02; H04B 5/40

(57) ABSTRACT

Provided are a communication system that includes a first communication apparatus with a first transmission electrode in an arc shape and a second reception electrode in an arc shape, and a second communication apparatus with a plurality of first reception electrodes in arc shapes and a plurality of second transmission electrodes in arc shapes. The first and second communication apparatuses are configured to rotate relative to each other. The first transmission electrode and at least one reception electrode of the plurality of first reception electrodes are arranged to face each other.

### BACKGROUND

### Field

The present disclosure relates to a communication system and a communication device.

### Description of the Related Art

In recent years, there have been known communication apparatuses that perform communication with an electromagnetic coupling between a rotating portion and a fixed portion, such as a joint portion of a robotic arm or a coupling portion between a network camera and a tripod head.

For example, Japanese Patent Application Laid-Open No. 2002-140801 discusses a technique for performing electromagnetic field communication between an electrode provided on a fixed substrate and another electrode on a rotating substrate separated from the fixed substrate while facing each other.

The technique of performing electromagnetic field communication is between a plurality of electrodes on one substrate and a plurality of electrodes on the other substrate, with the former and latter electrodes facing each other.

Discussed is a configuration in which shields are arranged between the plurality of electrodes block electromagnetic field, reducing interference therebetween.

### SUMMARY

The present disclosure is directed to a technique that reduces interference in bidirectional communication that is performed without shields and provides improved communication quality and a communication system of reduced size.

An aspect of the present disclosure provides a communication system that includes a first communication apparatus and a second communication apparatus. The first communication apparatus includes a first transmission electrode in an arc shape arranged on a circumference of a first circle, and a second reception electrode in an arc shape arranged on the circumference of the first circle. The second communication apparatus includes a plurality of first reception electrodes in arc shapes arranged on a circumference of a second circle, and a plurality of second transmission electrodes in arc shapes arranged on the circumference of the second circle. The first communication apparatus and the second communication apparatus are configured to rotate relative to each other around a line connecting a center point of the first circle and a center point of the second circle as a rotation axis, with the first transmission electrode and at least one electrode of the plurality of first reception electrodes being arranged to face each other and perform contactless communication, and with at least one electrode of the plurality of second transmission electrodes and the second reception electrode being arranged to face each other and perform contactless communication.

Further features of the present disclosure will become apparent from the following description of exemplary embodiments with reference to the attached drawings.

### BRIEF DESCRIPTION OF THE DRAWINGS

FIG. 1 is a block diagram illustrating an example of the configuration of a communication system according to an exemplary embodiment.

FIGS. 2A to 2D are diagrams each illustrating an example of the configuration of the communication system according to an exemplary embodiment.

FIGS. 3A to 3D are diagrams each illustrating an example of the communication system with an increased number of carriers according to an exemplary embodiment.

FIGS. 4A and 4B are diagrams each illustrating an example of electrode shapes of the communication system according to an exemplary embodiment.

FIGS. 5A to 5D are diagrams each illustrating an example of electrode shapes and a substrate shape of the communication system according to an exemplary embodiment.

FIGS. 6A to 6D are diagrams each illustrating a positional relationship between electrodes of the communication system according to an exemplary embodiment.

### DESCRIPTION OF THE EMBODIMENTS

Exemplary embodiments will now be described with reference to the drawings.

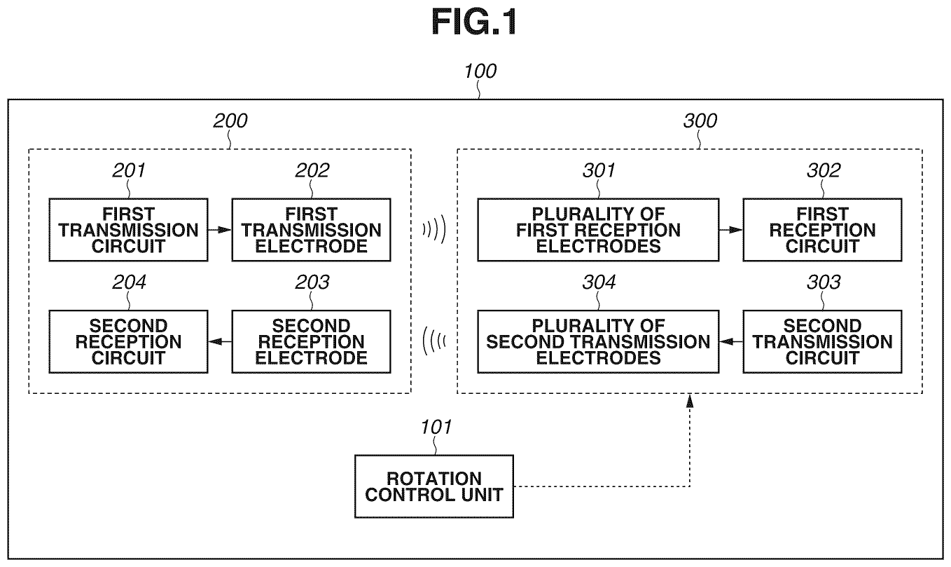

A first exemplary embodiment will be described. FIG. 1 is a block diagram illustrating an example of the configuration of a communication system 100 according to the first exemplary embodiment. The communication system 100 includes a fixed communication apparatus 200, a rotating communication apparatus 300, and a rotation controller 101. The fixed communication apparatus 200 and the rotating communication apparatus 300 perform electromagnetic field communication with an electromagnetic coupling.

The rotation controller 101 includes a motor, and controls so that electrodes on the fixed communication apparatus 200 and the rotating communication apparatus 300 faces each other with certain space subsequently on the same axis and rotate relative to each other around the axis.

While a case is described where the rotating communication apparatus 300 rotates according to the present exemplary embodiment, this is not a limitation as long as electrodes rotate relative to each other around a predetermined axis. The electrodes on the fixed communication apparatus 200 can rotate around the axis, or the electrodes on both the fixed communication apparatus 200 and the rotating communication apparatus 300 can rotate.

Further, if the electrodes rotate relative to each other around the predetermined axis, the entire fixed communication apparatus 200 and the entire rotating communication apparatus 300 can be rotated or not. The fixed communication apparatus 200 and the rotating communication apparatus 300 can be a first portion and a second portion of a single communication apparatus or can be separate apparatuses, respectively.

An electromagnetic coupling according to the present exemplary embodiment includes both an electric field coupling and a magnetic field coupling. Specifically, electromagnetic field communication between the electrodes can be performed through an electric field coupling, a magnetic field coupling, or a combination of an electric field coupling and a magnetic field coupling. In the present exemplary embodiment, a case where the electrodes make an electric field coupling to perform contactless communication will be described.

The fixed communication apparatus 200 includes a first transmission circuit 201, a first transmission electrode 202, a second reception electrode 203, and a second reception circuit 204. The rotating communication apparatus 300 includes a plurality of first reception electrodes 301, a first reception circuit 302, a second transmission circuit 303, and a plurality of second transmission electrodes 304.

The first transmission circuit 201 transmits signals to the first transmission electrode 202. The first transmission electrode 202 makes an electric field coupling by facing at least one of the plurality of first reception electrodes 301 and transmits the signals received from the first transmission circuit 201 to the electrode that is coupled through the electric field.

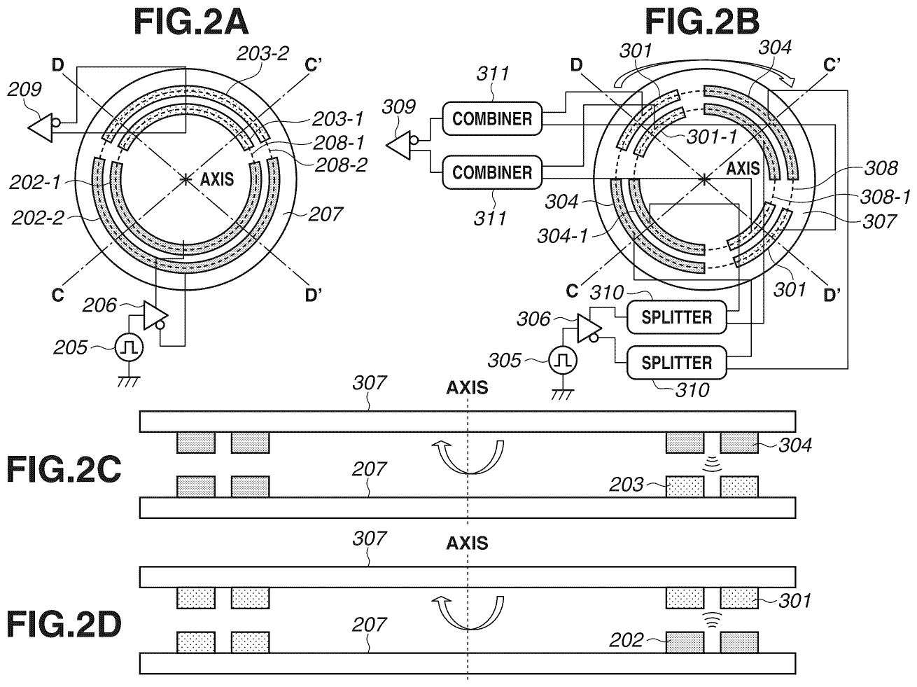

The plurality of first reception electrodes 301 transmits the signals received from the first transmission electrode 202 to the first reception circuit 302. The first reception circuit 302 combines the signals received from the plurality of first reception electrodes 301 using combiners 311 illustrated in FIG. 2B and restores the signals transmitted from the first transmission circuit 201.

A restoration unit of the first reception circuit 302 is a comparator circuit 309 illustrated in FIG. 2B, or another circuit can be used for the restoration. For example, if square wave signals are output from the first transmission circuit 201, differentiated signals are input to the first reception circuit 302 through an electric field coupling between the first transmission electrode 202 and the plurality of first reception electrodes 301. The comparator circuit 309 is provided in the first reception circuit 302 to enable signal restoration of the differentiated signals. The signal restoration can be performed by another circuit. This configuration performs one-way contactless communication to transmit signals contactlessly (e.g. wirelessly) from a fixed substrate 207 in FIG. 2A to a rotating substrate 307 in FIG. 2B.

The second transmission circuit 303 includes a signal source 305 and splitters 310 illustrated in FIG. 2B and transmits signals to the plurality of second transmission electrodes 304. This is not a limiting configuration of the second transmission circuit 303. For example, the second transmission circuit 303 can use a signal source with a fan-out function or can include a plurality of signal sources that transmit the same signals.

At least one of the plurality of second transmission electrodes 304 faces the second reception electrode 203 to make an electric field coupling, and the plurality of second transmission electrodes 304 transmits the signals received from the second transmission circuit 303 to the second reception electrode 203.

The second reception electrode 203 transmits the signals received from the plurality of second transmission electrodes 304 to the second reception circuit 204. The second reception circuit 204 receives the signals from the second reception electrode 203 and restores the signals transmitted from the second transmission circuit 303.

This configuration performs one-way contactless communication to transmit signals contactlessly from the rotating substrate 307 in FIG. 2B to the fixed substrate 207 in FIG. 2A, resulting in bidirectional communication together with the contactless communication from the fixed substrate 207 to the rotating substrate 307.

Components of blocks and positional relationships will now be described with reference to FIGS. 2A to 2D.

FIG. 2A is a diagram illustrating an example of the configuration of the fixed communication apparatus 200.

The fixed communication apparatus 200 includes the fixed substrate 207. The first transmission circuit 201 includes a signal source 205 and a differential buffer 206. The first transmission electrode 202 includes first transmission electrodes 202-1 and 202-2. The second reception electrode 203 includes second reception electrodes 203-1 and 203-2. The second reception circuit 204 includes a comparator circuit 209.

As illustrated in FIG. 2A, the signal source 205 transmits signals to the differential buffer 206. The differential buffer 206 transmits differential signals to the first transmission electrodes 202-1 and 202-2 based on the received signals.

The first transmission electrodes 202-1 and 202-2 provided on first circles 208-1 and 208-2, respectively, on the fixed substrate 207 receive the differential signals from the differential buffer 206. The inner first transmission electrode 202-1 is formed in an arc shape on the inner first circle 208-1. The outer first transmission electrode 202-2 is formed in an arc shape on the outer first circle 208-2.

A rigid substrate, such as Flame Retardant Type 4 (FR4), or a flexible substrate can be used as the fixed substrate 207, and the electrodes can be formed using copper patterns. In-phase signals are input to the inner first transmission electrode 202-1, and out-of-phase signals are input to the outer first transmission electrode 202-2.

The second reception electrodes 203-1 and 203-2 provided on the first circles 208-1 and 208-2, respectively, on the fixed substrate 207 transmit differential signals to the comparator circuit 209 in the second reception circuit 204. The comparator circuit 209 restores voltages generated in the second reception electrodes 203-1 and 203-2 with an electric field coupling to electric signals corresponding to the electric signals input to the second reception electrodes 203-1 and 203-2.

The inner second reception electrode 203-1 is formed in an arc shape on the inner first circle 208-1. The outer second reception electrode 203-2 is formed in an arc shape on the outer first circle 208-2. In-phase signals are input to the inner first transmission electrode 202-1, and out-of-phase signals are input to the outer first transmission electrode 202-2.

At this time, as the first transmission electrode 202 and the second reception electrode 203 are coupled through an electromagnetic field, interference noise increases. Since the first transmission electrode 202 and the second reception electrode 203 are not aligned parallel to each other, the interference noise can be reduced without a ground (GND) electrode.

FIG. 2B is a diagram illustrating an example of the configuration of the rotating communication apparatus 300. The rotating communication apparatus 300 includes the rotating substrate 307. The first reception circuit 302 includes the two combiners 311 and the comparator circuit 309. The second transmission circuit 303 includes the signal source 305, a differential buffer 306, and the two splitters 310.

As illustrated in FIG. 2B, the signal source 305 transmits signals to the differential buffer 306. The differential buffer 306 transmits differential signals to the two splitters 310 based on the received signals.

The two splitters 310 each distribute the differential signals to the plurality of second transmission electrodes 304. The inner splitter 310 distributes in-phase signals to the plurality of inner second transmission electrodes 304. The outer splitter 310 distributes out-of-phase signals to the plurality of outer second transmission electrodes 304.

The plurality of second transmission electrodes 304 provided on the second circle 308 on the rotating substrate 307 receives the differential signals from the differential buffer 306 via the splitters 310. Differential operations on the rotating substrate 307 are similar to those described above with reference to FIG. 2A, and the redundant descriptions thereof are omitted.

The rotation axis of the rotating substrate 307 is set to be substantially the same as that of the fixed substrate 207.

The plurality of second transmission electrodes 304 is each formed in an arc shape on the second circle 308.

Further, the plurality of first reception electrodes 301 formed on the second circle 308 on the rotating substrate 307 transmits differential signals to the two combiners 311 in the first reception circuit 302.

The inner combiner 311 combines the in-phase signals of the plurality of inner first reception electrodes 301.

The outer combiner 311 combines the out-of-phase signals of the plurality of outer first reception electrodes 301.

The comparator circuit 309 restores signals generated by the combiners 311 combining signals generated in the first reception electrodes 301 through an electric field coupling based on electric signals input to the plurality of first reception electrodes 301 and outputs as electric signals.

FIG. 2C is a cross-sectional view from C-C′ lines in FIGS. 2A and 2B. FIG. 2D is a cross-sectional view from D-D′ lines in FIGS. 2A and 2B. As illustrated in FIGS. 2C and 2D, the first circle 208 and the second circle 308 are set to face each other. The first circle 208 herein is a general term for the first circles 208-1 and 208-2. With this configuration, the second transmission electrode 304 and the second reception electrode 203 are arranged to face each other as illustrated in FIG. 2C. Further, the first transmission electrode 202 and the first reception electrode 301 are arranged to face each other as illustrated in FIG. 2D. Contactless communication is performed between the first transmission electrode 202 and the plurality of first reception electrodes 301, and between the plurality of second transmission electrodes 304 and the second reception electrode 203.

In FIGS. 2C and 2D, the rotating substrate 307 is the top side, and the fixed substrate 207 is the bottom side. The fixed substrate 207 and the rotating substrate 307 face each other with certain space, and the electrodes also face each other. On the C′-side in FIG. 2C, the second reception electrode 203 and the plurality of second transmission electrodes 304 face each other, and signals can be transmitted contactlessly from the rotating substrate 307 to the fixed substrate 207.

On the D′-side in FIG. 2D, in contrast, the first transmission electrode 202 and the plurality of first reception electrodes 301 face each other, and signals can be transmitted contactlessly from the fixed substrate 207 to the rotating substrate 307. In other words, bidirectional communication is performed without the transmission and reception electrodes parallel to each other.

This configuration reduces interference without a GND electrode in the rotary, contactless communication system 100, and provides improved quality in communication and reduced size of the communication system 100.

When single-end, multi-channel contactless communication is performed, separate signals can be input to the inner first transmission electrode 202-1 and the outer first transmission electrode 202-2. At this time, interference can be reduced without a GND electrode since the electrodes do not run parallel to each other between the first transmission electrode 202 and the second reception electrode 203, and between the plurality of first reception electrodes 301 and the plurality of second transmission electrodes 304. This provides improved quality in communication and reduced size of the communication system 100.

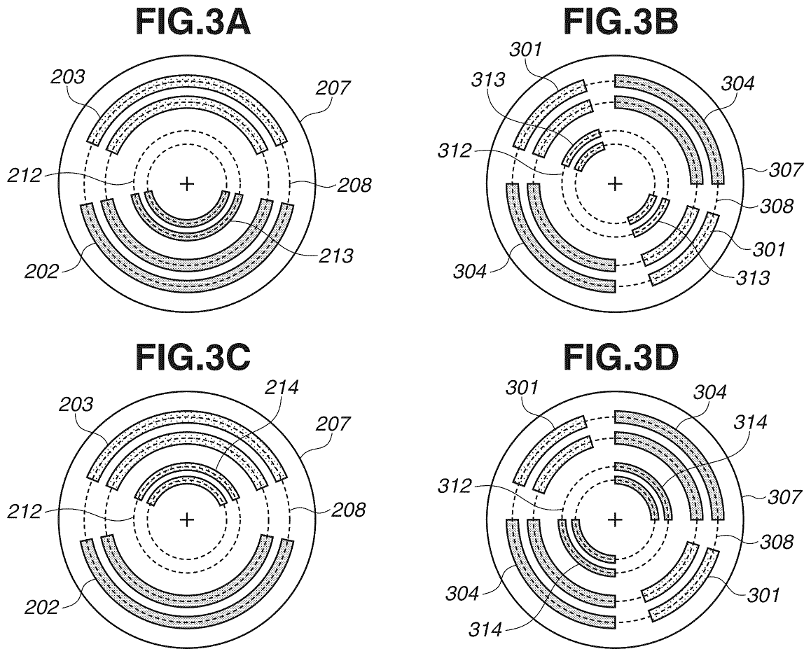

The number of electrodes can be increased based on the number of channels by providing a third circle 212, a third transmission electrode 213, a fourth circle 312, and a plurality of third reception electrodes 313 and arranging the third circle 212 and the fourth circle 312 to face each other as illustrated in FIGS. 3A and 3B. In this case, interference between the channels can be reduced with the plurality of transmission electrodes run parallel to each other and the plurality of reception electrodes run parallel to each other on the fixed substrate 207 and the rotating substrate 307.

When a relative angle between the fixed substrate 207 and the rotating substrate 307 changes, electrodes strongly coupled with electrodes on the fixed substrate change among the plurality of first reception electrodes 301 and second transmission electrodes 304. However, bidirectional communication can be performed as long as the electrodes face each other.

At this time, the plurality of second transmission electrodes 304 and the plurality of first reception electrodes 301 are substantially arranged point-symmetrically with respect to the rotation axis. The electrodes arranged point-symmetrically increases the angle of relative rotation between the electrodes facing each other, which increases the range of relative rotation angles enabling bidirectional contactless communication.

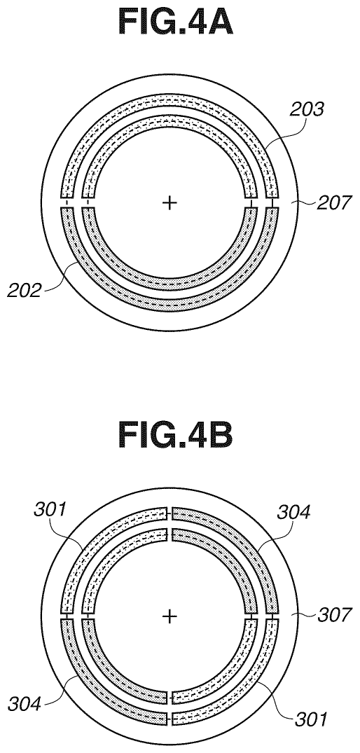

A case will now be described where, for example, the electrodes provided on the fixed substrate 207 and the rotating substrate 307 are shaped as illustrated in FIG. 4A and FIG. 4B, respectively. In this case, the first transmission electrode 202 and at least one of the plurality of first reception electrodes 301 face each other, and at least one of the plurality of second transmission electrodes 304 and the second reception electrode 203 face each other, which performs contactless communication regardless of the relative rotation angles. Specifically, contactless communication is performed without interruption even in a case with a rotation of 360 degrees or more. This configuration can be applied to applications that perform bidirectional contactless communication in unlimited rotation.

At this time, interference can be reduced further by the distances increased between the first transmission electrode 202 and the second reception electrode 203, and between the plurality of first reception electrodes 301 and the plurality of second transmission electrodes 304. However, the area where the electrodes on the fixed substrate 207 and the electrodes on the rotating substrate 307 face each other can decrease, which results in a relative rotation angle failing to perform bidirectional contactless communication. In other words, the relative rotation angle and the interference area are in a trade-off relationship, and it is suitable to adjust arc lengths of the electrodes depending on applications.

For example, an application with a small relative rotation angle reduces interference further with the distance increased between the first transmission electrode 202 and the second reception electrode 203. In contrast, in an application that involves establishing communication constantly even with a rotation of 360 degrees, a decrease of the distance between the first transmission electrode 202 and the second reception electrode 203 is illustrated in FIG. 4A.

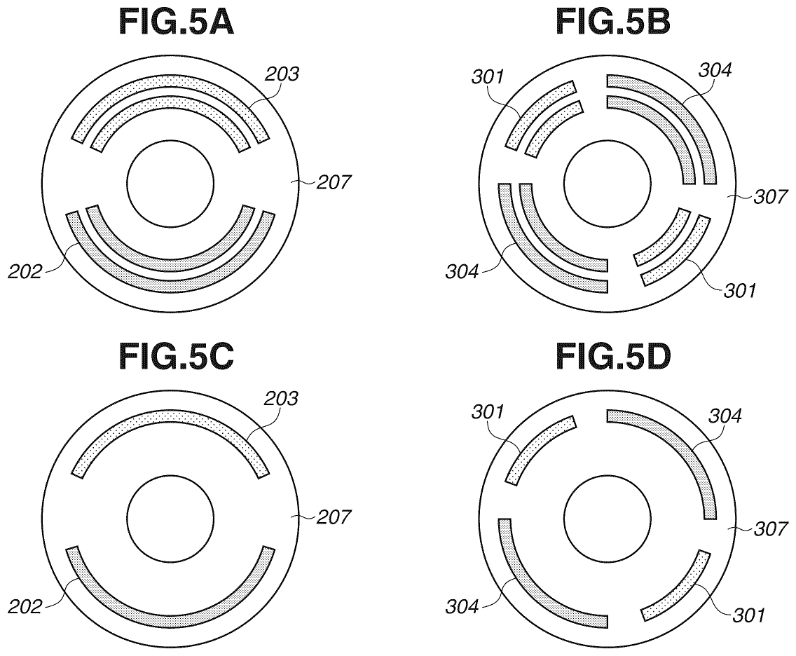

The shapes of the fixed substrate 207 and the rotating substrate 307 can be other shapes, such as a ring shape, or partial circular shape, as illustrated in FIGS. 5A and 5B. Further, in a case where any configuration with electrodes facing each other is employed, the electrodes can be formed using copper wires or iron pipes without the fixed substrate 207 or the rotating substrate 307.

While an example of performing differential contactless transmission has been described above, single-end contactless communication can be performed with a single electrode as illustrated in FIGS. 5C and 5D. Specifically, one first transmission electrode 202 and one second reception electrode 203 are arranged on one first circle 208 on the fixed substrate 207. Further, the plurality of first reception electrodes 301 and the plurality of second transmission electrodes 304 are arranged on one second circle 308 on the rotating substrate 307.

This configuration can reduce interference in electromagnetic field communication without shields, and provide improved quality in communication and reduced size of the communication system 100 configured to perform bidirectional communication with an electromagnetic coupling.

A second exemplary embodiment will now be described. The difference between the second exemplary embodiment and the first exemplary embodiment will be described.

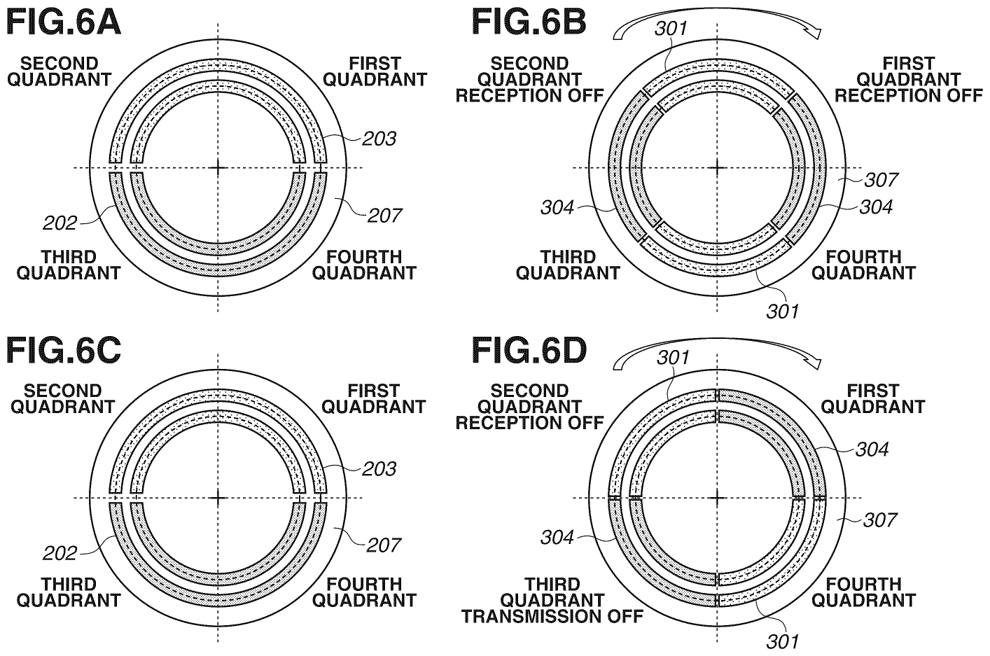

FIGS. 6A to 6D are diagrams illustrating examples of the configurations of the fixed substrate 207 and the rotating substrate 307 according to the second exemplary embodiment. States of communication will be described where the fixed substrate 207 and the rotating substrate 307 are each divided into four quadrants facing each other.

First, a relationship of communication between the fixed substrate 207 as in FIG. 6A and the rotating substrate 307 as in FIG. 6B will be described. Contactless communication from the fixed substrate 207 to the rotating substrate 307 is performed through an electric field coupling between the first transmission electrode 202 and the plurality of first reception electrodes 301 in the third and fourth quadrants where the first transmission electrode 202 and the plurality of first reception electrodes 301 face each other. Contactless communication from the rotating substrate 307 to the fixed substrate 207 is performed through an electric field coupling between the plurality of second transmission electrodes 304 and the second reception electrode 203 in the first and second quadrants where the plurality of second transmission electrodes 304 and the second reception electrode 203 face each other.

At this time, the electric field coupling between the first transmission electrode 202 and the first reception electrode 301 in the first and second quadrants is extremely small, leading to extremely small impact on the contactless communication. However, there is an electric field from the plurality of second transmission electrodes 304 that cause interference, so that signals from the first reception electrode 301 in the first and second quadrants are not received to further reduce the effect of interference.

Specifically, switches made between the electrodes for receiving signals based on degrees of coupling of electrodes and relative rotation angles between the fixed substrate 207 and the rotating substrate 307 reduces the effect of interference, providing further improved quality in communication. This can be achieved, for example, by switching electrodes for receiving signals based on relative rotation angles using a switch or a multiplexer, or by relatively amplifying signals of electrodes with high degree of coupling using an attenuator or an amplifier.

The first reception circuit 302 does not receive signals from the first reception electrode 301 in the first and second quadrants, but receives signals from the first reception electrode 301 in the third and fourth quadrants and restores the received signals. This can reduce the effect of interference, providing improved quality in communication.

A relationship of communication between the fixed substrate 207 as in FIG. 6C and the rotating substrate 307 as in FIG. 6D will now be described.

Contactless communication from the fixed substrate 207 to the rotating substrate 307 is performed through an electric field coupling between the first transmission electrode 202 and the plurality of first reception electrodes 301 in the fourth quadrant where the first transmission electrode 202 and the plurality of first reception electrodes 301 face each other. Contactless communication from the rotating substrate 307 to the fixed substrate 207 is performed through an electric field coupling between the plurality of second transmission electrodes 304 and the second reception electrode 203 in the first quadrant where the plurality of second transmission electrodes 304 and the second reception electrode 203 face each other.

At this time, the electric field coupling between the first transmission electrode 202 and the first reception electrode 301 in the second quadrant is extremely small, leading to extremely small impact on the contactless communication. However, there is an electric field from the plurality of second transmission electrodes 304 that cause interference, so that signals from the first reception electrode 301 in the second quadrant are not received to further reduce the effect of interference.

The first reception circuit 302 does not receive signals from the first reception electrode 301 in the second quadrant, but receives signals from the first reception electrode 301 in the fourth quadrant and restores the received signals. This can reduce the effect of interference to provide improved quality in communication.

Further, the electric field coupling between the second transmission electrode 304 and the second reception electrode 203 in the third quadrant is extremely small, leading to extremely small impact on the contactless communication. Without transmitting signals from the second transmission electrode 304 in the third quadrant, the effect of interference is further reduced.

Specifically, switches made between the electrodes for transmitting signals based on degrees of coupling of electrodes and relative rotation angles between the fixed substrate 207 and the rotating substrate 307 reduce the effect of interference to provide further improved quality in communication. This can be achieved, for example, by switching electrodes for transmitting signals based on relative rotation angles using a switch or a multiplexer, or by relatively amplifying signals of electrodes with high degree of coupling using an attenuator or an amplifier.

The second transmission circuit 303 does not transmit signals to the second transmission electrode 304 in the third quadrant but transmits signals to the second transmission electrode 304 in the first quadrant. This can reduce the effect of interference to provide improved quality in communication.

With this configuration, the control of the input and output of signals to and from the electrodes based on a relative rotation angle between the fixed substrate 207 and the rotating substrate 307 can reduce the effect of interference to provide further improved quality in communication.

As described above, the communication system 100 in FIG. 1 includes the first communication apparatus 200 and the second communication apparatus 300. In FIG. 2A, the first communication apparatus 200 includes the first transmission electrode 202-1 in an arc shape arranged on the circumference of the first circle 208-1 and the second reception electrode 203-1 in an arc shape arranged on the circumference of the first circle 208-1.

In FIG. 2B, the second communication apparatus 300 includes the plurality of first reception electrodes 301-1 in arc shapes arranged on the circumference of the second circle 308-1 and the plurality of second transmission electrodes 304-1 in arc shapes arranged on the circumference of the second circle 308-1. The second circle 308-1 herein is the inner circle of the two second circles 308. The plurality of first reception electrodes 301-1 is the plurality of inner first reception electrodes 301. The plurality of second transmission electrodes 304-1 is the plurality of inner second transmission electrodes 304.

As illustrated in FIGS. 2A to 2D, the first communication apparatus 200 and the second communication apparatus 300 are configured to rotate relative to each other around a line connecting the center points of the first circle 208-1 and the second circle 308-1 as the rotation axis.

The first transmission electrode 202 and at least one of the plurality of first reception electrodes 301-1 are arranged to face each other and perform contactless communication. Further, at least one of the plurality of second transmission electrodes 304-1 and the second reception electrode 203-1 are arranged to face each other and perform contactless communication.

The radii of the first circle 208-1 and the second circle 308-1 are substantially equal. The first communication apparatus 200 and the second communication apparatus 300 are configured to rotate relative to each other by 360 degrees.

In FIG. 4B, the sum of the average arc length of the plurality of first reception electrodes 301 and the average arc length of the plurality of second transmission electrodes 304 is substantially half the length of the circumference of the second circle 308.

In FIG. 3A, the first communication apparatus 200 further includes the third transmission electrode 213 in an arc shape arranged on the circumference of the third circle 212. The third transmission electrode 213 runs parallel to the first transmission electrode 202. The center points of the first circle 208 and the third circle 212 are substantially identical with each other, and radii of the first circle 208 and the third circle 212 differ from each other.

In FIG. 3B, the second communication apparatus 300 further includes the plurality of third reception electrodes 313 in arc shapes arranged on the circumference of the fourth circle 312. The plurality of third reception electrodes 313 runs parallel to the plurality of first reception electrodes 301. The center points of the second circle 308 and the fourth circle 312 are substantially identical with each other, and the radii of the second circle 308 and the fourth circle 312 differ from each other.

The radii of the third circle 212 and the fourth circle 312 are substantially equal. The third transmission electrode 213 and at least one of the plurality of third reception electrodes 313 are arranged to face each other and perform contactless communication.

In FIG. 3C, the first communication apparatus 200 further includes a fourth reception electrode 214 in an arc shape arranged on the circumference of the third circle 212. The fourth reception electrode 214 runs parallel to the second reception electrode 203. The center points of the first circle 208 and the third circle 212 are substantially identical with each other, and the radii of the first circle 208 and the third circle 212 differ from each other.

In FIG. 3D, the second communication apparatus 300 further includes a plurality of fourth transmission electrodes 314 in arc shapes arranged on the circumference of the fourth circle 312. The plurality of fourth transmission electrodes 314 runs parallel to the plurality of second transmission electrodes 304. The center points of the second circle 308 and the fourth circle 312 are substantially identical with each other, and the radii of the second circle 308 and the fourth circle 312 differ from each other.

The radii of the third circle 212 and the fourth circle 312 are substantially equal. At least one of the plurality of fourth transmission electrodes 314 and the fourth reception electrode 214 are arranged to face each other and perform contactless communication.

The communication system 100 can include a combination of the configurations illustrated in FIGS. 3A and 3B and the configurations illustrated in FIGS. 3C and 3D.

In FIGS. 2A to 2D, the first transmission electrodes 202-1 and 202-2, the plurality of first reception electrodes 301, the plurality of second transmission electrodes 304, and the second reception electrodes 203-1 and 203-2 are each a differential pair of electrodes.

In FIG. 2A, the first communication apparatus 200 further includes the first differential buffer 206 configured to transmit differential signals to the first transmission electrode 202. Further, the first communication apparatus 200 further includes the comparator circuit (a first restoration unit) 209 configured to restore signals of the second reception electrodes 203-1 and 203-2. The signals of the differential pair of the second reception electrodes 203-1 and 203-2 are input to the comparator circuit 209.

In FIG. 2B, the second communication apparatus 300 further includes the second differential buffer 306 configured to transmit differential signals to the splitters 310 and the splitters 310 configured to distribute signals to the plurality of second transmission electrodes 304. Further, the second communication apparatus 300 further includes the combiners 311 configured to combine signals of the plurality of first reception electrodes 301 and the comparator circuit (a second restoration unit) 309 configured to restore the signals combined by the combiners 311. The signals of the differential pair of the first reception electrodes 301 are input to the comparator circuit 309.

The plurality of first reception electrodes 301 is arranged point-symmetrically with respect to the rotation axis.

Further, the plurality of second transmission electrodes 304 is arranged point-symmetrically with respect to the rotation axis.

In FIG. 1, the communication system 100 further includes the rotation control unit 101 configured to control the first communication apparatus 200 and the second communication apparatus 300 to rotate relative to each other.

In FIGS. 6A to 6D, the first reception circuit 302 selects, attenuates, or amplifies signals to be received from one of the plurality of first reception electrodes 301 based on a relative rotation angle between the first communication apparatus 200 and the second communication apparatus 300.

Further, the first reception circuit 302 can select, attenuate, or amplify signals to be received from one of the plurality of first reception electrodes 301 based on degrees of coupling of an electric field, a magnetic field, or both between the first transmission electrode 202 and at least one of the plurality of first reception electrodes 301.

Further, in FIGS. 6C and 6D, the second transmission circuit 303 selects, attenuates, or amplifies signals to be transmitted to one of the plurality of second transmission electrodes 304 based on a relative rotation angle between the first communication apparatus 200 and the second communication apparatus 300.

Further, the second transmission circuit 303 can select, attenuate, or amplify signals to be transmitted to one of the plurality of second transmission electrodes 304 based on degrees of coupling of an electric field, a magnetic field, or both between at least one of the plurality of second transmission electrodes 304 and the second reception electrode 203.

In FIG. 6A, the first transmission electrode 202 is not arranged in the first quadrant or the second quadrant of the first circle 208 or the second circle 308, but is arranged in the third quadrant and the fourth quadrant of the first circle 208 and the second circle 308. In FIG. 6B, the second communication apparatus 300 includes the first reception electrode 301 arranged in the first quadrant and the second quadrant, and the first reception electrode 301 arranged in the third quadrant and the fourth quadrant. The first reception circuit 302 does not receive signals of the first reception electrode 301 arranged in the first quadrant and the second quadrant but receives signals of the first reception electrode 301 arranged in the third quadrant and the fourth quadrant.

In FIG. 6C, the first transmission electrode 202 is not arranged in the first quadrant or the second quadrant of the first circle 208 or the second circle 308, but is arranged in the third quadrant and the fourth quadrant of the first circle 208 and the second circle 308. In FIG. 6D, the second communication apparatus 300 includes the first reception electrode 301 arranged in the second quadrant and the first reception electrode 301 arranged in the fourth quadrant. The first reception circuit 302 does not receive signals of the first reception electrode 301 arranged in the second quadrant but receives signals of the first reception electrode 301 arranged in the fourth quadrant.

In FIG. 6C, the second reception electrode 203 is arranged in the first quadrant and the second quadrant of the first circle 208 and the second circle 308, but is not arranged in the third quadrant or the fourth quadrant of the first circle 208 and the second circle 308. In FIG. 6D, the second communication apparatus 300 includes the second transmission electrode 304 arranged in the first quadrant and the second transmission electrode 304 arranged in the third quadrant. The second transmission circuit 303 does not transmit signals to the second transmission electrode 304 arranged in the third quadrant but transmits signals to the second transmission electrode 304 arranged in the first quadrant.

According to the first and the second exemplary embodiments, the communication system 100 is a communication system that performs bidirectional communication with an electromagnetic coupling and can reduce interference in electromagnetic field communication without shields, which provides improved quality in communication and reduced size of the communication system.

All the exemplary embodiments described above merely illustrate specific examples of implementation of the present disclosure, and the technical scope of the present disclosure should not be interpreted narrowly by the exemplary embodiments. Specifically, the present disclosure can be implemented in various forms without departing from its technical concept or major features.

The exemplary embodiments include the following configurations.

### Configuration 1

A communication system comprising:
a first communication apparatus; and
a second communication apparatus,
wherein the first communication apparatus includes:
   a first transmission electrode in an arc shape arranged on a circumference of a first circle; and
   a second reception electrode in an arc shape arranged on the circumference of the first circle,
wherein the second communication apparatus includes:
   a plurality of first reception electrodes in arc shapes arranged on a circumference of a second circle; and
   a plurality of second transmission electrodes in arc shapes arranged on the circumference of the second circle,
wherein the first communication apparatus and the second communication apparatus are configured to rotate relative to each other around a line connecting a center point of the first circle and a center point of the second circle as a rotation axis,
wherein the first transmission electrode and at least one electrode of the plurality of first reception electrodes are arranged to face each other and perform contactless communication, and
wherein at least one electrode of the plurality of second transmission electrodes and the second reception electrode are arranged to face each other and perform contactless communication.

### Configuration 2

The communication system according to configuration 1, wherein a radius of the first circle and a radius of the second circle are substantially equal.

### Configuration 3

The communication system according to configuration 1 or 2, wherein the first communication apparatus is configured to rotate relative to the second communication apparatus by up to and including 360 degrees.

### Configuration 4

The communication system according to any one of configurations 1 to 3, wherein a sum of an average arc length of the plurality of first reception electrodes and an average arc length of the plurality of second transmission electrodes is substantially half of a length of the circumference of the second circle.

### Configuration 5

The communication system according to any one of configurations 1 to 4,
wherein the first communication apparatus further includes a third transmission electrode in an arc shape arranged on a circumference of a third circle,
wherein the second communication apparatus further includes a plurality of third reception electrodes in arc shapes arranged on a circumference of a fourth circle,
wherein the third transmission electrode runs parallel to the first transmission electrode,
wherein the plurality of third reception electrodes runs parallel to the plurality of first reception electrodes,
wherein the center point of the first circle and a center point of the third circle are substantially identical to each other, and the radius of the first circle and a radius of the third circle differ from each other,
wherein the center point of the second circle and a center point of the fourth circle are substantially identical to each other, and the radius of the second circle and a radius of the fourth circle differ from each other, and
wherein the third transmission electrode and at least one electrode of the plurality of third reception electrodes are arranged to face each other and perform contactless communication.

### Configuration 6

The communication system according to configuration 5, wherein the radius of the third circle and the radius of the fourth circle are substantially equal.

### Configuration 7

The communication system according to any one of configurations 1 to 6,
wherein the first communication apparatus further includes a fourth reception electrode in an arc shape arranged on the circumference of the third circle,
wherein the second communication apparatus further includes a plurality of fourth transmission electrodes in arc shapes arranged on the circumference of the fourth circle,
wherein the fourth reception electrode runs parallel to the second reception electrode,
wherein the plurality of fourth transmission electrodes runs parallel to the plurality of second transmission electrodes,
wherein the center point of the first circle and the center point of the third circle are substantially identical to each other, and the radius of the first circle and the radius of the third circle differ from each other,
wherein the center point of the second circle and the center point of the fourth circle are substantially identical to each other, and the radius of the second circle and the radius of the fourth circle differ from each other, and
wherein at least one electrode of the plurality of fourth transmission electrodes and the fourth reception electrode are arranged to face each other and perform contactless communication.

### Configuration 8

The communication system according to configuration 7, wherein the radius of the third circle and the radius of the fourth circle are substantially equal.

### Configuration 9

The communication system according to any one of configurations 1 to 8, wherein the first transmission electrode and the plurality of first reception electrodes, and the plurality of second transmission electrodes and the second reception electrode are each a differential pair of electrodes.

### Configuration 10

The communication system according to any one of configurations 1 to 9, wherein the second communication apparatus further includes a combiner configured to combine signals of the plurality of first reception electrodes.

### Configuration 11

The communication system according to configuration 10,
wherein the first communication apparatus further includes a first comparator circuit configured to restore signals of the second reception electrode, and
wherein the second communication apparatus further includes a second comparator circuit configured to restore the signals combined by the combiner.

### Configuration 12

The communication system according to configuration 11, wherein the first transmission electrode and the plurality of first reception electrodes, and the plurality of second transmission electrodes and the second reception electrode are each a differential pair of electrodes, and wherein a signal of the differential pair of electrodes is input to the first comparator circuit and the second comparator circuit.

### Configuration 13

The communication system according to any one of configurations 1 to 12, wherein the second communication apparatus further includes a splitter configured to distribute signals to the plurality of second transmission electrodes.

### Configuration 14

The communication system according to configuration 13,
wherein the first transmission electrode and the plurality of first reception electrodes, and the plurality of second transmission electrodes and the second reception electrode are each a differential pair of electrodes,
wherein the first communication apparatus further includes a first differential buffer configured to transmit differential signals to the first transmission electrode, and
wherein the second communication apparatus further includes a second differential buffer configured to transmit differential signals to the splitter.

### Configuration 15

The communication system according to any one of configurations 1 to 14, wherein the plurality of first reception electrodes is arranged point-symmetrically with respect to the rotation axis.

### Configuration 16

The communication system according to any one of configurations 1 to 15, wherein the plurality of second transmission electrodes is arranged point-symmetrically with respect to the rotation axis.

### Configuration 17

The communication system according to any one of configurations 1 to 16, further comprising a rotation controller configured to control the first communication apparatus and the second communication apparatus to rotate relative to each other.

### Configuration 18

The communication system according to any one of configurations 1 to 17, wherein the second communication apparatus further includes a first reception circuit configured to select, attenuate, or amplify signals to be received from one electrode of the plurality of first reception electrodes based on a relative rotation angle between the first communication apparatus and the second communication apparatus.

### Configuration 19

The communication system according to any one of configurations 1 to 18, wherein the second communication apparatus further includes a second transmission circuit configured to select, attenuate, or amplify signals to be transmitted to one electrode of the plurality of second transmission electrodes based on the relative rotation angle between the first communication apparatus and the second communication apparatus.

### Configuration 20

The communication system according to any one of configurations 1 to 17, wherein the second communication apparatus further includes a first reception circuit configured to select, attenuate, or amplify signals to be received from one of the plurality of first reception electrodes based on a degree of coupling of an electric field, a magnetic field, or both between the first transmission electrode and at least one electrode of the plurality of first reception electrodes.

### Configuration 21

The communication system according to any one of configurations 1 to 17 and 20, wherein the second communication apparatus further includes a second transmission circuit configured to select, attenuate, or amplify signals to be transmitted to one electrode of the plurality of second transmission electrodes based on a degree of coupling of an electric field, a magnetic field, or both between at least one of the plurality of second transmission electrodes and the second reception electrode.

### Configuration 22

The communication system according to any one of configurations 1 to 17,
wherein none of the plurality of first transmission electrodes are arranged in a first quadrant or a second quadrant of the first circle or the second circle, with the plurality of first transmission electrodes being arranged in third quadrants and fourth quadrants of the first circle and the second circle,
wherein the plurality of first reception electrodes includes a first reception electrode arranged in the first quadrant, and another second quadrant and the first reception electrode arranged in the third quadrant and the fourth quadrant, and
wherein the second communication apparatus further includes a first reception circuit configured not to receive signals of the first reception electrodes arranged in the first quadrant and the second quadrant but to receive signals of the another first reception electrodes arranged in the third quadrant and the fourth quadrant.

### Configuration 23

The communication system according to any one of configurations 1 to 17,
wherein none of the first transmission electrode are arranged in a first quadrant or a second quadrant of the first circle or the second circle, with the plurality of first transmission electrodes being arranged in third quadrants and fourth quadrants of the first circle and the second circle,
wherein the plurality of first reception electrodes includes a first reception electrode arranged in the second quadrant, and another first reception electrode arranged in the fourth quadrant, and
wherein the second communication apparatus further includes a first reception circuit configured not to receive signals of the first reception electrode arranged in the second quadrant but to receive signals of the another first reception electrode arranged in the fourth quadrant.

### Configuration 24

The communication system according to any one of configurations 1 to 17 and 23,
wherein the second reception electrode is arranged in the first quadrants and the second quadrants of the first circle and the second circle, but is not arranged in the third quadrant or the fourth quadrant of the first circle or the second circle,
wherein the plurality of second transmission electrodes includes a second transmission electrode arranged in the first quadrant and another second transmission electrode arranged in the third quadrant, and
wherein the second communication apparatus further includes a second transmission circuit configured not to transmit signals to the another second transmission electrode arranged in the third quadrant, but to transmit signals to the second transmission electrode arranged in the first quadrant.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-203012, filed Nov. 30, 2023, which is hereby incorporated by reference herein in its entirety.

What is claimed is:

1. A communication system comprising:
a first communication apparatus; and
a second communication apparatus,
wherein the first communication apparatus includes:
a first transmission electrode in an arc shape arranged on a circumference of a first circle; and
a second reception electrode in an arc shape arranged on the circumference of the first circle,
wherein the second communication apparatus includes:
a plurality of first reception electrodes in arc shapes arranged on a circumference of a second circle; and
a plurality of second transmission electrodes in arc shapes arranged on the circumference of the second circle,
wherein the first communication apparatus and the second communication apparatus are configured to rotate relative to each other around a line connecting a center point of the first circle and a center point of the second circle as a rotation axis,
wherein the first transmission electrode and at least one electrode of the plurality of first reception electrodes are arranged to face each other and perform contactless communication, and
wherein at least one electrode of the plurality of second transmission electrodes and the second reception electrode are arranged to face each other and perform contactless communication.

2. The communication system according to claim 1, wherein a radius of the first circle and a radius of the second circle are substantially equal.

3. The communication system according to claim 1, wherein the first communication apparatus is configured to rotate relative to the second communication apparatus by up to and including 360 degrees.

4. The communication system according to claim 1, wherein a sum of an average arc length of the plurality of first reception electrodes and an average arc length of the plurality of second transmission electrodes is substantially half of a length of the circumference of the second circle.

5. The communication system according to claim 1,
wherein the first communication apparatus further includes a third transmission electrode in an arc shape arranged on a circumference of a third circle,
wherein the second communication apparatus further includes a plurality of third reception electrodes in arc shapes arranged on a circumference of a fourth circle,
wherein the third transmission electrode runs parallel to the first transmission electrode,
wherein the plurality of third reception electrodes runs parallel to the plurality of first reception electrodes,
wherein the center point of the first circle and a center point of the third circle are substantially identical to each other, and a radius of the first circle and a radius of the third circle differ from each other,
wherein the center point of the second circle and a center point of the fourth circle are substantially identical to each other, and a radius of the second circle and a radius of the fourth circle differ from each other, and
wherein the third transmission electrode and at least one electrode of the plurality of third reception electrodes are arranged to face each other and perform contactless communication.

6. The communication system according to claim 5, wherein the radius of the third circle and the radius of the fourth circle are substantially equal.

7. The communication system according to claim 1,
wherein the first communication apparatus further includes a fourth reception electrode in an arc shape arranged on a circumference of a third circle,
wherein the second communication apparatus further includes a plurality of fourth transmission electrodes in arc shapes arranged on a circumference of a fourth circle,
wherein the fourth reception electrode runs parallel to the second reception electrode,
wherein the plurality of fourth transmission electrodes runs parallel to the plurality of second transmission electrodes,
wherein the center point of the first circle and a center point of the third circle are substantially identical to each other, and a radius of the first circle and a radius of the third circle differ from each other,
wherein the center point of the second circle and a center point of the fourth circle are substantially identical to each other, and a radius of the second circle and a radius of the fourth circle differ from each other, and
wherein at least one electrode of the plurality of fourth transmission electrodes and the fourth reception electrode are arranged to face each other and perform contactless communication.

8. The communication system according to claim 7, wherein the radius of the third circle and the radius of the fourth circle are substantially equal.

9. The communication system according to claim 1, wherein the first transmission electrode and the plurality of first reception electrodes, and the plurality of second transmission electrodes and the second reception electrode are each a differential pair of electrodes.

10. The communication system according to claim 1, wherein the second communication apparatus further includes a combiner configured to combine signals of the plurality of first reception electrodes.

11. The communication system according to claim 10,
wherein the first communication apparatus further includes a first comparator circuit configured to restore a signal of the second reception electrode, and
wherein the second communication apparatus further includes a second comparator circuit configured to restore a signal combined by the combiner.

12. The communication system according to claim 11,
wherein the first transmission electrode and the plurality of first reception electrodes, and the plurality of second transmission electrodes and the second reception electrode are each a differential pair of electrodes, and
wherein a signal of the differential pair of electrodes is input to the first comparator circuit and the second comparator circuit.

13. The communication system according to claim 1, wherein the second communication apparatus further includes a splitter configured to distribute a signal to the plurality of second transmission electrodes.

14. The communication system according to claim 13,
wherein the first transmission electrode and the plurality of first reception electrodes, and the plurality of second transmission electrodes and the second reception electrode are each a differential pair of electrodes,
wherein the first communication apparatus further includes a first differential buffer configured to transmit a differential signal to the first transmission electrode, and
wherein the second communication apparatus further includes a second differential buffer configured to transmit a differential signal to the splitter.

15. The communication system according to claim 1, wherein at least one of the plurality of first reception electrodes and the plurality of second transmission electrodes are arranged point-symmetrically with respect to the rotation axis.

16. The communication system according to claim 1, further comprising a rotation controller configured to control the first communication apparatus and the second communication apparatus to rotate relative to each other.

17. The communication system according to claim 1, wherein the second communication apparatus further includes a first reception circuit configured to select, attenuate, or amplify a signal to be received from one of the plurality of first reception electrodes based on a relative rotation angle between the first communication apparatus and the second communication apparatus.

18. The communication system according to claim 1, wherein the second communication apparatus further includes a second transmission circuit configured to select, attenuate, or amplify a signal to be transmitted to one electrode of the plurality of second transmission electrodes based on a relative rotation angle between the first communication apparatus and the second communication apparatus.

19. The communication system according to claim 1, wherein the second communication apparatus further includes a first reception circuit configured to select, attenuate, or amplify a signal to be received from one electrode of the plurality of first reception electrodes based on a degree of coupling of an electric field, a magnetic field, or both between the first transmission electrode and at least one of the plurality of first reception electrodes.

20. The communication system according to claim 1, wherein the second communication apparatus further includes a second transmission circuit configured to select, attenuate, or amplify a signal to be transmitted to one electrode of the plurality of second transmission electrodes based on a degree of coupling of an electric field, a magnetic field, or both between at least one of the plurality of second transmission electrodes and the second reception electrode.

21. The communication system according to claim 1,
wherein none of the plurality of first transmission electrodes are arranged in a first quadrant or a second quadrant of the first circle or the second circle, with the plurality of first transmission electrodes being arranged in third quadrants and fourth quadrants of the first circle and the second circle,
wherein the plurality of first reception electrodes includes a first reception electrode arranged in the first quadrant and the second quadrant, and another first reception electrode arranged in the third quadrant and the fourth quadrant, and
wherein the second communication apparatus further includes a first reception circuit configured not to receive a signal of the first reception electrode arranged in the first quadrant and the second quadrant, but to receive a signal of the another first reception electrode arranged in the third quadrant and the fourth quadrant.

22. The communication system according to claim 1,
wherein none of the first transmission electrode are arranged in a first quadrant or a second quadrant of the first circle and the second circle, with the plurality of first transmission electrodes being arranged in third quadrants and fourth quadrants of the first circle and the second circle,
wherein the plurality of first reception electrodes includes a first reception electrode arranged in the second quadrant, and another first reception electrode arranged in the fourth quadrant, and
wherein the second communication apparatus further includes a first reception circuit configured not to receive a signal of the first reception electrode arranged in the second quadrant, but to receive a signal of the another first reception electrode arranged in the fourth quadrant.

23. The communication system according to claim 1,
wherein the second reception electrode is arranged in first quadrants and second quadrants of the first circle and the second circle, but is not arranged in a third quadrant or a fourth quadrant of the first circle or the second circle,
wherein the plurality of second transmission electrodes includes a second transmission electrode arranged in the first quadrant and another second transmission electrode arranged in the third quadrant, and
wherein the second communication apparatus further includes a second transmission circuit configured not to transmit a signal to the another second transmission electrode arranged in the third quadrant, but to transmit a signal to the second transmission electrode arranged in the first quadrant.

24. A communication device comprising:
a first communication apparatus; and
a second communication apparatus,
wherein the first communication apparatus includes:
a first transmission electrode arranged on a circumference of a first circle; and
a second reception electrode arranged on the circumference of the first circle,
wherein the second communication apparatus includes:
a plurality of first reception electrodes arranged on a circumference of a second circle; and
a plurality of second transmission electrodes arranged on the circumference of the second circle,
wherein the first communication apparatus and the second communication apparatus are configured to rotate around a rotation axis,
wherein the first transmission electrode and at least one electrode of the plurality of first reception electrodes are configured to perform contactless communication, and
wherein at least one electrode of the plurality of second transmission electrodes and the second reception electrode are configured to perform contactless communication.
